(19) United States
(12) Patent Application Publication
(10) Pub. No.: US 2019/0033474 A1
(43) Pub. Date: Jan. 31, 2019

(54) USE OF MULTI-FUNCTIONAL CROSS-LINKING AGENTS IN THE MANUFACTURE OF PULSE SHAPE DISCRIMINATING PLASTIC SCINTILLATORS, THE SCINTILLATOR, AND METHODS OF USING THE SAME

(71) Applicants: Henok A. Yemam, Golden, CO (US); Adam Mahl, Denver, CO (US); Allison Lim, Golden, CO (US); Alan Sellinger, Golden, CO (US); Uwe Greife, Golden, CO (US)

(72) Inventors: Henok A. Yemam, Golden, CO (US); Adam Mahl, Denver, CO (US); Allison Lim, Golden, CO (US); Alan Sellinger, Golden, CO (US); Uwe Greife, Golden, CO (US)

(21) Appl. No.: 16/150,138

(22) Filed: Oct. 2, 2018

Related U.S. Application Data
(63) Continuation-in-part of application No. 16/005,368, filed on Jun. 11, 2018.
(60) Provisional application No. 62/567,006, filed on Oct. 2, 2017.
(60) Provisional application No. 62/517,766, filed on Jun. 9, 2017.

(51) Int. Cl. G01T 3/06; C09K 11/06; C09K 11/02; C08K 5/353; C08J 3/24

(52) U.S. Cl. CPC G01T 3/06; C09K 11/06; C09K 11/025; C08J 2335/02; C08J 3/24; C09K 2211/1018; C08K 5/353

(57) ABSTRACT

The present invention is directed to systems and methods for producing an improved pulse shape discriminating (PSD) scintillator by including a cross-linking agent, such as BPA-DM, in the polymer from which the scintillator is machined, and to PSD scintillators produced thereby. The cross-linking agent could also be used for plastic scintillators with significant incorporation of specialized dopants (boron, lead or bismuth) for thermal neutron, fast neutron and/or gamma radiation detection.

### CROSS REFERENCE TO RELATED APPLICATION

This application is a continuation-in-part of U.S. patent application Ser. No. 16/005,368, filed on Jun. 11, 2018, which claims priority under 35 U.S.C. § 119(e) to U.S. Provisional Patent Application Ser. No. 62/517,766 filed Jun. 9, 2017. This application also claims priority under 35 U.S.C. § 119(e) to U.S. Provisional Patent Application Ser. No. 62/567,006 filed Oct. 2, 2017. Each of these references are incorporated herein in their entirety by reference.

### GOVERNMENT LICENSE RIGHTS

This invention was made with government support under DHS-14-DN-077-AR-NC7 and DHS-DNDO-77-001 awarded by the Department of Homeland Security. The government has certain rights in the invention.

### FIELD OF THE INVENTION

This invention relates to the use of multi-functional cross-linking agents in the manufacture of pulse shape discriminating (PSD) plastic scintillators with improved properties, and in particular to the use of aromatic acrylates and methacrylates, including for example bisphenol A dimethacrylate (BPA-DM), fluorinated aromatic acrylates and methacrylates, and related agents to improve the mechanical stability, machinability, light output, and overall quality of PSD plastic scintillators.

### BACKGROUND

To improve both the fluorescence responses and neutron sensitivity of plastic scintillators and allow for differentiation of signals between neutron radiation from the gamma radiation background, it is necessary to manufacture scintillators that are capable of PSD but retain certain mechanical properties, (such as hardness, thermal stability and stability over time) of their constituent plastic materials that allow for the production and deployment of large scale scintillators. To date, each of the proposed methods for achieving the desired mechanical properties has met with, at best, limited success. For example, the 2,5-diphenyloxazole (“PPO”) overdoping method disclosed by U.S. Patent Application Publication 2014/0027646 to Zaitseva et al. (“Zaitseva”), the entirety of which is incorporated by reference herein, produces soft plastic that is difficult to machine into a high-quality scintillator, due to the concentrations of PPO (at least about 10 wt. %) needed to achieve PSD.

There is thus a need in the art for methods of improving the hardness and mechanical stability of plastic scintillators, including PPO-overdoped plastic scintillators, without sacrificing light output or PSD capability. It is further advantageous for such methods to require only reagents that are widely and/or commercially available.

### SUMMARY

The present invention provides PSD scintillators with improved mechanical properties. The improved mechanical properties are achieved by increased cross-linking of the polymeric material of the scintillator, using bisphenol A dimethacrylate (BPA-DM) or related cross-linking agents.

It is one aspect of the invention to provide a method for producing a PSD capable scintillator, comprising cross-linking a polymeric material with a cross-linking agent and forming the scintillator of the cross-linked polymeric material.

It is another aspect of the invention to provide a PSD capable scintillator with improved mechanical properties, comprising a polymeric material that has been cross-linked with a cross-linking agent.

An aspect of the invention is a method for producing a pulse shape discriminating (scintillator. The method includes combining between about 20 wt. % and 40 wt. % of a first dopant, between about 0.01 wt. % and about 2 wt. % of a secondary dopant, at least 0.5 wt. % of at least one cross-linking agent, and a balance of at least one monomer, wherein at least one monomer is a styrene-based monomer, methacrylate monomer, a benzyl acrylate, or a benzyl methacrylate to form a mixture. The mixture is purged with an inert gas. The mixture is then cured at a temperature between about 60° C. and about 110° C. to form the pulse shape discriminating capable scintillator. An aspect of the invention is a pulse shape discriminating scintillator that includes a polymeric material. The polymeric material includes between about 20 wt. % and 30 wt. % of at least one first dopant, between about 0.01 wt. % and about 2 wt. % of a second dopant, and a balance of at least one monomer, wherein the at least one monomer is a styrene-based monomer, methacrylate monomer, a benzyl acrylate, or a benzyl methacrylate. The hardness of the pulse shape discriminating scintillator is between about 15 and about 100 Shore D.

An aspect of the invention is a method to use a pulse shaped discriminating scintillator. The scintillator enhances the detection of neutrons. A material of the pulse shaped discriminating scintillator includes a first or second scintillator. The first scintillator includes between about 20 wt. % and about 40 wt. % of a first dopant, between about 0.1 wt. % and about 1 wt. % of a second dopant, and the balance being a polymer of monomers, wherein a monomer is a styrene-based monomer, methacrylate monomer, a benzyl acrylate, or a benzyl methacrylate. The second scintillator includes between about 1 wt. % and about 20 wt. % of a first dopant, between about 0.1 wt. % and about 1 wt. % of a second dopant, between about 5 wt. % and about 40 wt. % of a third dopant, and the balance being a polymer of monomers, wherein a monomer is a styrene-based monomer, methacrylate monomer, a benzyl acrylate, or a benzyl methacrylate. The hardness of the pulse shape discriminating scintillator is between about 15 and about 100 Shore D.

An aspect of the invention is a method to use a pulse shaped discriminating scintillator. The scintillator enhances the photopeak resolution for gamma spectroscopy. A material of the pulse shaped discriminating scintillator includes a first or second scintillator. The first scintillator includes between about 20 wt. % and about 40 wt. % of a first dopant, between about 0.1 wt. % and about 1 wt. % of a second dopant, and the balance being a polymer of monomers, wherein a monomer is a styrene-based monomer, methacrylate monomer, a benzyl acrylate, or a benzyl methacrylate. The second scintillator includes between about 1 wt. % and about 20 wt. % of a first dopant, between about 0.1 wt. % and about 1 wt. % of a second dopant, between about 5 wt. % and about 40 wt. % of a third dopant, and the balance being a polymer of monomers, wherein a monomer is a styrene-based monomer, methacrylate monomer, a benzyl acrylate, or a benzyl methacrylate. The hardness of the pulse shape discriminating scintillator is between about 15 and about 100 Shore D.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 illustrates two machined polymer samples having an about 25 wt. % and an about 30 wt. % PPO content, respectively, and each having an about 5 wt. % BPA-DM content, according to embodiments of the present invention;

FIG. 2 illustrates the light yield of an about 20 wt. % PPO overdoped polymer samples with varying degrees of cross-linking, according to embodiments of the present invention;

FIG. 3 illustrates the PSD spectrum of an about 30% PPO doped polymer sample, according to embodiments of the present invention;

FIG. 4A is a PSD Figure of Merit (FoM) for an about 25 wt. % PPO overdoped polymer samples with varying degrees of cross-linking at energies between 100 keVₑₑ and about 200 keVₑₑ, according to embodiments of the present invention;

FIG. 4B is a PSD FoM for an about 25 wt. % PPO overdoped polymer samples with varying degrees of cross-linking at energies between 400 keVₑₑ and about 600 keVₑₑ, according to embodiments of the present invention;

FIG. 5 illustrates the relationship between hardness and concentration of BPA-DM for samples with 20 wt. %, 25 wt. % or 30 wt. % PPO;

FIG. 6A illustrates a sample containing 20 wt. % PPO and 5 wt. % BPAF-DM;

FIG. 6B illustrates a sample containing 20 wt. % PPO and 8 wt. % BPAF-DM

FIG. 6C illustrates a sample containing 25 wt. % PPO and 5 wt. % BPAF-DM

FIG. 6D illustrates a sample containing 25 wt. % PPO and 8 wt. % BPAF-DM

FIG. 6E illustrates a sample containing 30 wt. % PPO and 5 wt. % BPAF-DM

FIG. 6F illustrates a sample containing 30 wt. % PPO and 8 wt. % BPAF-DM

FIG. 7A illustrate a sample comprising about 20 wt. % PPO and no BPA-DM;

FIG. 7B illustrate a sample comprising about 20 wt. % PPO and 0.5 wt. % BPA-DM;

FIG. 7C illustrate a sample comprising about 20 wt. % PPO and 1 wt. % BPA-DM;

FIG. 7D illustrate a sample comprising about 20 wt. % PPO and 2 wt. % BPA-DM;

FIG. 7E illustrate a sample comprising about 20 wt. % PPO and 3 wt. % BPA-DM;

FIG. 7F illustrate a sample comprising about 20 wt. % PPO and 4 wt. % BPA-DM;

FIG. 7G illustrate a sample comprising about 20 wt. % PPO and 5 wt. % BPA-DM;

FIG. 7H illustrate a sample comprising about 20 wt. % PPO and 6 wt. % BPA-DM;

FIG. 7I illustrate a sample comprising about 20 wt. % PPO and 8 wt. % BPA-DM;

FIG. 7J illustrate a sample comprising about 20 wt. % PPO and 10 wt. % BPA-DM;

FIG. 8A illustrate a sample comprising about 25 wt. % PPO and no BPA-DM;

FIG. 8B illustrate a sample comprising about 25 wt. % PPO and 0.5 wt. % BPA-DM;

FIG. 8C illustrate a sample comprising about 25 wt. % PPO and 1 wt. % BPA-DM;

FIG. 8D illustrate a sample comprising about 25 wt. % PPO and 2 wt. % BPA-DM;

FIG. 8E illustrate a sample comprising about 25 wt. % PPO and 3 wt. % BPA-DM;

FIG. 8F illustrate a sample comprising about 25 wt. % PPO and 4 wt. % BPA-DM;

FIG. 8G illustrate a sample comprising about 25 wt. % PPO and 5 wt. % BPA-DM;

FIG. 8H illustrate a sample comprising about 25 wt. % PPO and 6 wt. % BPA-DM;

FIG. 8I illustrate a sample comprising about 25 wt. % PPO and 8 wt. % BPA-DM;

FIG. 9A illustrate a sample comprising about 30 wt. % PPO and no BPA-DM;

FIG. 9B illustrate a sample comprising about 30 wt. % PPO and 0.5 wt. % BPA-DM;

FIG. 9C illustrate a sample comprising about 30 wt. % PPO and 1 wt. % BPA-DM;

FIG. 9D illustrate a sample comprising about 30 wt. % PPO and 2 wt. % BPA-DM;

FIG. 9E illustrate a sample comprising about 30 wt. % PPO and 3 wt. % BPA-DM;

FIG. 9F illustrate a sample comprising about 30 wt. % PPO and 4 wt. % BPA-DM;

FIG. 9G illustrate a sample comprising about 30 wt. % PPO and 5 wt. % BPA-DM;

FIG. 9H illustrate a sample comprising about 30 wt. % PPO and 6 wt. % BPA-DM;

FIG. 9I illustrate a sample comprising about 30 wt. % PPO and 8 wt. % BPA-DM;

FIG. 9J illustrate a sample comprising about 30 wt. % PPO and 10 wt. % BPA-DM;

FIG. 10 illustrates the radiation response spectra of ¹³⁷Cs Compton edge features of plastic scintillators with varying concentrations (0-10 wt. %) of BPA-DM and 20 wt. % PPO;

FIG. 11 illustrates the ¹³⁷Cs Compton edge features of BPAF-DM linked samples (detailed in Table 1);

FIG. 12 illustrates the DSC curve for BPAF-DM;

FIG. 13 illustrates the thermal decomposition curves for cross-linked and uncross-linked samples;

FIG. 14 illustrates relative comparison of polymerization rate at 80° C. between pure VT, VT with BPA-DM, and VT with BPAF-DM;

FIG. 15A illustrates a first dopant, 2,5-diphenyloxazole (PPO), that can be used with the invention;

FIG. 15B illustrates a first dopant, 9,9-dimethyl-2-phenyl-9H-fluorene (PhF), that can be used with the invention;

FIG. 15C illustrates a second dopant, 9,10-diphenylantracene (DPA), that can be used with the invention;

FIG. 15D illustrates a second dopant, 9-9-dimethyl-2,7-di((E)-styryl)-9H-fluorene (SFS), that can be used with the invention;

FIG. 15E illustrates a second dopant, 1,4-bis(5-phenyloxazol-2-yl) benzene (POPOP), that can be used with the invention;

FIG. 15F illustrates a second dopant, 1,4-bis(2-methylstyryl)benzene (Bis-MSB), that can be used with the invention;

FIG. 15G illustrates a third dopant, bis(pinacolato)diboron (B₂Pin₂), that can be used with the invention;

FIG. 15H illustrates a third dopant, m-carborane, that can be used with the invention;

FIG. 15I illustrates a third dopant, 4,4,5,5-tetramethyl-2-phenyl-1,3,2-dioxaborolane (MBB), where the boron atom can also be enriched in the boron-10 isotope, that can be used with the invention;

FIG. 15J illustrates a third dopant, lithium salicylate, that can be used with the invention; and

FIG. 15K illustrates a third dopant, triphenylbismuthane, that can be used with the invention.

### DETAILED DESCRIPTION OF THE INVENTION

The present invention is directed to systems and methods for producing an improved PSD scintillator by including a cross-linking agent, such as BPA-DM, in the polymer from which the scintillator is machined. The PSD scintillators produced thereby are also an aspect of the invention as are methods of using the scintillators.

Embodiments of the present invention utilize aromatic methacrylates, including for example BPA-DM, the molecular structure of which is illustrated below, and related cross-linking agents in the manufacture of PSD scintillators.

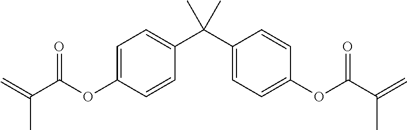 [SMILES: C=C(C)C(=O)Oc1ccc(C(C)(C)c2ccc(OC(=O)C(=C)C)cc2)cc1]

Other aromatic acrylates and methacrylates, including fluorinated acrylates, or bifunctional aromatic acrylates, can also be used with the invention. One potential fluorinated aromatic methacrylate includes fluorinated bisphenol A dimethacrylate (BPAF-DM), which is depicted below.

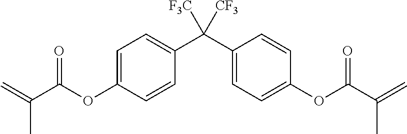 [SMILES: C=C(C)C(=O)Oc1ccc(C(c2ccc(OC(=O)C(=C)C)cc2)(C(F)(F)F)C(F)(F)F)cc1]

While BPA-DM is described throughout the Specification, it is understood that other aromatic acrylates and methacrylates, including BPAF-DM, can be utilized with deviating from the invention.

Similar to the excitation structures of other plastic scintillator components, such as the matrix material poly(vinyl toluene) (PVT) and the fluorescent dopant 2,5-diphenyloxazole (PPO), the molecular structure of BPA-DM provides aromatic π-electrons. The aromatic π-electrons are important as they enhance the energy transfer from the incoming radiation (aromatic groups are excited and energy transfer to the dopants) to the fluorescent dopants for better scintillation properties. Non-aromatic crosslinkers “dilute” the aromaticity and result in degraded scintillation properties. Lastly, the dimethacrylate (also referred to as “diacrylate”) based crosslinkers are important as they do not lead to benzylic groups that are known to oxidize overtime and may lead to reduced scintillator reliability. For example, divinylbenzene base crosslinkers are known to lead to increased amounts of benzylic groups upon crosslinking that can lead to decreased scintillator reliability. For this reason, divinylbenzene base crosslinkers are not used with the present invention.

Other cross-linking agents do not provide the advantages of the present invention, and the relative paucity of aromatic π-electrons made with other cross-linking agents can significantly degrade the scintillator performance. The use of a combined cross-linking agent/aromatic structure allows a cross-linked PSD scintillator to match or even improve upon the performance of a non-cross-linked scintillator, while also improving the mechanical properties of the scintillator. Finally, the addition of at least one cross-linker improves the dopant stability within the matrix and leads to enhanced PSD properties.

The aromatic methacrylates, including BPA-DM, cross-linking methods disclosed herein provide a hard and robust plastic scintillator, even when the formulation is highly overdoped with PPO or other specialized dopants for gamma radiation and/or fast or thermal neutron discrimination. Polymer samples produced by the methods illustratively disclosed herein can be produced on commercial scales using only commercially available ingredients. As further described in the following Example, the novel molecular structure of BPA-DM and related cross-linking agents allows for improved dopant stability, light yield and pulse shape discrimination characteristics in the final plastic scintillators.

An aspect of the invention is a method for producing a pulse shape discriminating scintillator. The method includes combining between about 20 wt. % and 40 wt. % of the mixture of a first dopant, between about 0.01 wt. % and about 1 wt. % of the mixture of a secondary dopant, at least 0.5 wt. % of the mixture of at least one cross-linking agent, and a balance of at least one monomer, wherein a monomer is a styrene-based monomer, methacrylate monomer, a benzyl acrylate, or a benzyl methacrylate to form the mixture. The mixture is purged with an inert gas, and cured at a temperature between about 20° C. and about 120° C. to form the pulse shape discriminating scintillator.

The molecular structure of the cross-linking agent provides aromatic π-electrons. The cross-linker can be a methacrylate or acrylate crosslinker. The cross-linker can include BPA-DM, BPAF-DM, BPA(halogen)-DM, a bifunctional aromatic acrylate and combinations thereof. The cross-linker is not a divinyl benzene. When divinyl benzene is used as the cross-linker, the scintillator can be degraded compared to cross-linkers of the prior art or cross-linkers of the present invention. The amount of the cross-linker in the mixture is between about 0.5 wt. % and about 10 wt. % of the mixture. The cross-linker crosslinks the monomer to form a polymer. In some embodiments, the crosslinker can comprise between about 0 wt. % and about 0.5 wt. % of the mixture of the polymer.

The first dopant, or primary fluor, can be 2,5-diphenyloxazole (“PPO”), 9,9-dimethyl-2-phenyl-9H-fluorene (“PhF”), or combinations thereof. The second dopant, i.e. a wavelength shifter, can be 1,4-bis(5-phenyloxazol-2-yl) benzene (“POPOP”), 9,10-diphenylantracene (“DPA”), 9-9-dimethyl-2,7-di((E)-styryl)-9H-flourene (“SPS”), 1,4-bis(2-methylstyryl)benzene (“Bis-MSB”), and combinations thereof. The first dopant and the second dopant provide scintillation to the scintillator.

In some embodiments, the mixture can include at least one initiator. The initiator can be a radical initiator, such as a thermal radical initiator or a radical photo initiator. The initiator can be used to initiate cross-linking of the monomer in the mixture. One of skill in the art would understand that an initiator can decrease the time required for cross-linking of the polymer to occur. One skilled in the art would also understand that many different types of radical initiators could be used, and are so expansive in the number that could be applicable, that it would be impossible to list all of the potential initiators herein. One skilled in the art would also understand that an initiator is not required to polymerize the monomers as the polymerization reaction can occur without the initiator, but the polymerization time may increase. One skilled in the art would also understand other methods of cross-linking the polymer in the presence or absence of the initiator can be used. For example, the curing time and temperature of the mixture can be adjusted to promote polymerization of the monomers to form the polymer.

When an initiator is used, the curing temperature can depend upon the initiator. For example, in some embodiments, the initiator can be azobisisobutyronitrile (“AIBN”). The curing temperature can be between about 60° C. and about 90° C. when AIBN is used as the initiator. Other suitable initiators can include benzoyl peroxide, tert-amyl peroxybenzoate, 4, 4,-Azobis(4-(cyclohexanecarbonitrile), 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, and combinations thereof. The curing temperature in general can be between about 20° C. and about 120° C. This general curing temperature of between 20° C. and about 120° C. can be utilized if the initiator is used or if an initiator is not included in the mixture. The curing time can be between about 24 and about 72 hours.

When the initiator is used, it is typically combined with the monomer to form a pre-mixture, which is then combined with the mixture (i.e. the mixture containing the first and second dopants, cross-linker and potentially other components). The amount of initiator in the pre-mixture (i.e. initiator and monomer mixture) can be between about 0.01 wt. % and about 0.1 wt. %. The premixture can be used as the amount of monomer in the mixture. It is also possible to perform the curing process without adding initiators, thus using only thermal energy. In some embodiments, the curing process without the initiators can occur at a temperature greater than about 90° C. In some embodiments, the temperature can be between about 25° C. and about 100° C., in some embodiments about 90° C.

The monomer used with the invention can be a vinyl monomer or acrylate monomer or methacrylate monomer. Suitable monomers include vinyl toluene, styrene, methyl methacrylate, phenyl acrylate, phenyl methacrylate, benzyl acrylate, benzyl methacrylate and combinations thereof. The amount of the monomer can typically be the balance of the other components such that the total amount of the components in the mixture equals 100 wt. %. In some embodiments, incidental materials can also be present in the mixture, typically in amounts of up to about 5 wt. % of the mixture.

The mixture is purged prior to curing. Purging can remove oxygen present in the mixture and surrounding the mixture. The mixture can be purged with an inert gas for between about 5 and 30 minutes at a temperature between about 20° C. and about 40° C. Suitable inert gases include argon, nitrogen, and combinations thereof. In some embodiments, the mixture can be purged during the curing step.

The mixture can be subjected to a second cure. The second cure can occur after the first curing step. The second curing step can be continuous to the first cure step (i.e. after the first cure is complete at the first cure temperature, raising the temperature from the first curing temperature to the second curing temperature without removing the material from the heating device). Alternatively, the second curing step can occur after the first temperature has been reduced, for example to room temperature, then increased to the second curing temperature. The second cure can occur at a temperature of between about 80° C. and about 120° C., for between about 12 hours and about 48 hours, and at a pressure of between about 7.6 psi and about 9.8 psi.

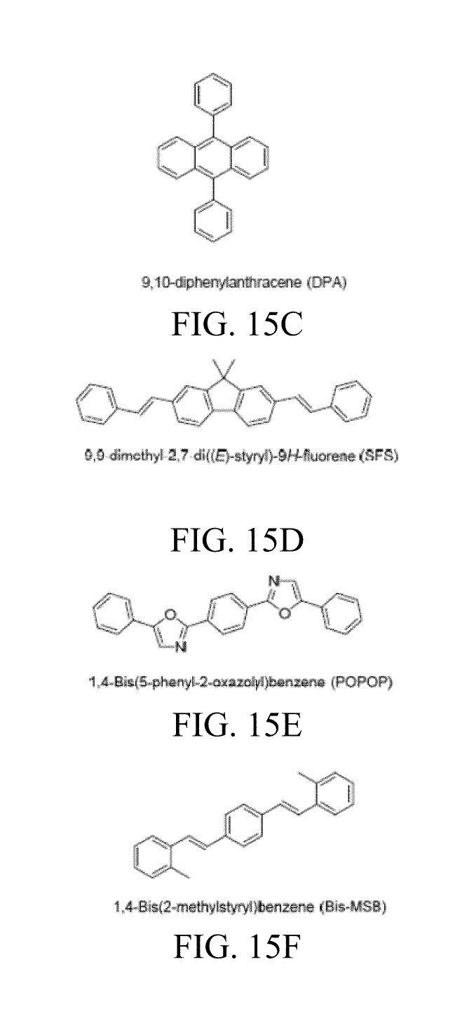

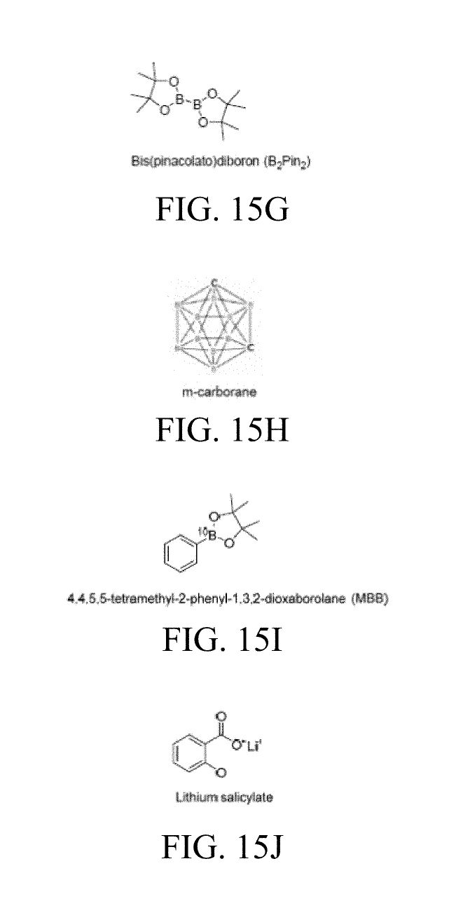

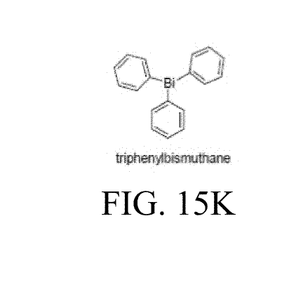

The mixture can include a third dopant. The third dopant can enhance thermal neutron detection or induce photopeak for gamma spectroscopy. Suitable third dopants include, but are not limited to, bis(pinacolato)diboron (B₂Pin₂), m-carborane, 4,4,5,5-tetramethyl-2-phenyl-1,3,2-dioxaborolane (MBB), 2,2′,2″-(benzene-1,2,4-triyl)tris(4,4,5,5-tetramethyl-1,3,2-dioxaborolane) (124TrBB), lithium salicylate, triphenylbismuthane, or combinations thereof. The boron can be either from natural sources or enriched in 10B, that is the neutron active isotope of boron as it has a high neutron cross-section of 3840 barns. U.S. Pat. No. 9,864,077, entitled “Boron Containing Organic/Hybrid Scintillation Materials for Gamma and Neutron Detection”, describes boron containing organic scintillation materials, and is incorporated by reference in its entirety. When the third dopant is used, the amount of the other components, typically the first dopant and/or monomer, can be reduced. As a result, the amount of the third dopant can be between about 0 wt. % and about 40 wt. % of the mixture. However, when the third dopant is included in the mixture, then the amount of the third dopant can be greater than about 0 wt. % and about 40 wt. % of the mixture. FIG. 15A-15K provide images of suitable first, second and third dopants that can be used with the invention.

Table 1 includes non-limiting examples of particular mixtures. Samples I contain about 20 wt. % of PPO (first dopant), Sample II contain about 25 wt. % of PPO, and Samples III contain about 30 wt. % of PPO. All samples contain 0.1 wt. % of POPOP (second dopant/wavelength shifter). All amounts in the table are approximate.

TABLE 1

| | Light Yield | | | | | | | | | | | |
|---|---|---|---|---|---|---|---|---|---|---|---|---|
| | (% of | | | FoM @ | | | FoM @ | | | Hardness | | |
| BPA-DM | BC-408) | | | 100-200 keVₑₑ | | | 400-600 keVₑₑ | | | (Shore-D) | | |
| (wt. %) | I | II | III | I | II | III | I | II | III | I | II | III |
| 0 | 87 | 81 | 89 | 1.03 | 1.16 | 1.38 | 1.47 | 1.71 | 1.88 | 66 | 65 | 6 |
| 0.5 | 91 | 86 | 92 | 1.11 | 1.20 | 1.37 | 1.54 | 1.67 | 1.85 | 70 | 68 | 29 |
| 1 | 89 | 86 | 91 | 1.08 | 1.24 | 1.41 | 1.58 | 1.75 | 1.94 | 74 | 68 | 43 |
| 2 | 86 | 89 | 100 | 1.07 | 1.25 | 1.44 | 1.48 | 1.66 | 1.90 | 75 | 70 | 37 |
| 3 | 92 | 86 | 97 | 1.11 | 1.17 | 1.43 | 1.55 | 1.70 | 1.93 | 75 | 71 | 39 |
| 4 | 89 | 92 | 99 | 1.08 | 1.23 | 1.34 | 1.57 | 1.71 | 2.00 | 75 | 71 | 56 |
| 5 | 93 | 86 | 95 | 1.12 | 1.16 | 1.32 | 1.55 | 1.70 | 1.95 | 77 | 73 | 60 |
| 6 | 91 | 89 | 97 | 1.05 | 1.23 | 1.39 | 1.52 | 1.68 | 1.90 | 79 | 73 | 59 |
| 8 | 90 | 92 | 92 | 1.09 | 1.25 | 1.35 | 1.54 | 1.66 | 2.05 | 74 | 74 | 66 |
| 10 | 88 | 94 | 93 | 1.08 | 1.16 | 1.35 | 1.53 | 1.71 | 1.82 | 77 | 75 | 73 |
| 5 wt. % | 89 | 92 | 93 | 1.10 | 1.15 | 1.39 | 1.53 | 1.60 | 1.91 | 75 | 70 | 45 |
| (BPAF-DM) | | | | | | | | | | | | |
| 8 wt. % | 89 | 90 | 93 | 1.09 | 1.24 | 1.37 | 1.52 | 1.73 | 2.00 | 78 | 73 | 63 |
| (BPAF-DM) | | | | | | | | | | | | |

The hardness of the pulse shape discriminating scintillator formed with methods of the invention can be between about 15 Shore-D and about 100 Shore-D as measured pursuant to ASTM D2240. In some embodiments, the Shore-D hardness can be between about 50 and about 95, and in some embodiments, the Shore-D hardness can be about 85. Furthermore, the pulse shape discriminating scintillator does not lose greater than about 0.1 wt. % (each) of the first dopant, and the second dopant over a period of between about 1 day and about 5 years. Additionally, the scintillator does not discolor after one year, which is another indication that the scintillator is stable over time. The scintillator can also be resistant to crazing over a period greater than at least one year. One issue known when a cross-linker is not utilized as described with regard to the present invention is that the dopants can seep from the scintillator, crystallize and cloud the scintillator. While not being bound by theory, it is believed that the inclusion of the cross-linker in the present invention can reduce or prevent the crystallization and clouding.

An aspect of the invention is a scintillator. The scintillator comprises between about 2-wt. % and about 40 wt. % of a first dopant, between about 0.01 wt. % and about 2 wt. % of a second dopant, and the balance being a polymer. An average hardness of the scintillator, as measured pursuant to ASTM D2240, is between about 15 and about 100 Shore-D.

The scintillator can include trace amounts of incidental materials. Incidental materials include. In some embodiments, the scintillator can include unreacted cross-linker. In some embodiments, the scintillator can include unreacted monomer. The cross-linker can be methacrylate or acrylate crosslinker, or combinations thereof, and combinations thereof. In some embodiments, the scintillator can include unreacted initiator.

The scintillator can be machined to any particular shape for particular applications. The scintillator can be machined using cutting machines, including saws, lathes, and can be sanded and polished.

The molecular structure of the cross-linking agent provides aromatic π-electrons. The cross-linker can include BPA-DM, BPAF-DM, BPA(halogen)-DM, a bifunctional aromatic acrylate and combinations thereof. The cross-linker is not a divinyl benzene. When divinyl benzene is used as the cross-linker, the scintillator can be degraded compared to cross-linkers of the prior art or cross-linkers of the present invention.

The first dopant, or primary fluor, can be 2,5-diphenyloxazole (“PPO”), 9,9-dimethyl-2-phenyl-9H-fluorene (“PhF”), or combinations thereof. The second dopant, i.e. a wavelength shifter, can be 1,4-bis(5-phenyloxazol-2-yl) benzene (“POPOP”), 9,10-diphenylantracene (“DPA”), 9-9-dimethyl-2,7-di((E)-styryl)-9H-flourene (“SPS”), 1,4-bis(2-methylstyryl)benzene (“Bis-MSB”), and combinations thereof. The first dopant and the second dopant provide scintillation to the scintillator.

In some embodiments, the scintillator can include at least one initiator. The initiator can be a radical initiator, such as a thermal radical initiator or a radical photo initiator. The initiator can be used to initiate cross-linking of the monomer in the mixture. In some embodiments, the initiator can be azobisisobutyronitrile (“AIBN”). Other suitable initiators can include benzoyl peroxide, tert-amyl peroxybenzoate, 4, 4,-Azobis(4-(cyclohexanecarbonitrile), 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclo-hexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, and combinations thereof.

The monomer used with the invention to form a polymer can formed from a vinyl monomer or acrylate monomer, a styrene-based monomer, or methacrylate monomer. Suitable monomers include vinyl toluene, styrene, methyl methacrylate, phenyl acrylate, phenyl methacrylate, benzyl acrylate, benzyl methacrylate and combinations thereof. The monomer polymerizes to form polymers of the monomer.

The scintillator can include a third dopant. The third dopant can enhance thermal neutron detection or induce photopeak for gamma spectroscopy. Suitable third dopants include, but are not limited to, bis(pinacolato)diboron (B₂Pin₂), m-carborane, 4,4,5,5-tetramethyl-2-phenyl-1,3,2-dioxaborolane (MBB), 2,2′,2″-(benzene-1,2,4-triyl)tris(4,4,5,5-tetramethyl-1,3,2-dioxaborolane) (124TrBB) lithium salicylate, triphenylbismuthane, or combinations thereof. The boron can be either from natural sources or enriched in 10B, that is the neutron active isotope of boron as it has a high neutron cross-section of 3840 barns. U.S. Pat. No. 9,864,077, entitled “Boron Containing Organic/Hybrid Scintillation Materials for Gamma and Neutron Detection, describes boron containing organic scintillation materials, and is incorporated by reference in its entirety. When the third dopant is used, the amount of the other components, typically the first dopant and/or monomer/polymer, can be reduced. As a result, the amount of the third dopant can be between about 0 wt. % and about 40 wt. % of the mixture. However, when the third dopant is included in the scintillator, then the amount of the third dopant can be greater than about 0 wt. % and about 40 wt. % of the mixture. FIG. 15A-15K provide images of suitable first, second and third dopants that can be used with the invention.

The hardness of the pulse shape discriminating scintillator formed with methods of the invention can be between about 15 Shore-D and about 100 Shore-D as measured pursuant to ASTM D2240. In some embodiments, the Shore-D hardness can be between about 50 and about 95, and in some embodiments, the Shore-D hardness can be about 85. Furthermore, the pulse shape discriminating scintillator does not lose greater than about 0.1 wt. % (each) of the first dopant, and the second dopant over a period of between about 1 day and about 5 years. Additionally, the scintillator does not discolor after one year, which is another indication that the scintillator is stable over time. The scintillator can also be resistant to crazing over a period greater than at least one year. One issue known when a cross-linker is not utilized as described with regard to the present invention is that the dopants can seep from the scintillator, crystallize and cloud the scintillator. While not being bound by theory, it is believed that the inclusion of the cross-linker in the present invention can reduce or prevent the crystallization and clouding.

An aspect of the invention is a method to produce a scintillator. The method includes combining between about 1 wt. % and 20 wt. % of the mixture of a first dopant, between about 0.01 wt. % and about 1 wt. % of the mixture of a secondary dopant, between about 5 wt. % and about 40 wt. % of a third dopant, at least 0.5 wt. % of the mixture of at least one cross-linking agent, and a balance of at least one monomer to form a mixture. Purging the mixture with an inert gas, and curing the mixture at a temperature between about 20° C. and about 120° C. to form the pulse shaped discriminating scintillator.

The molecular structure of the cross-linking agent provides aromatic π-electrons. The cross-linker can be a methacrylate or acrylate crosslinker. The cross-linker can include BPA-DM, BPAF-DM, BPA(halogen)-DM, a bifunctional aromatic acrylate and combinations thereof. The cross-linker is not a divinyl benzene. When divinyl benzene is used as the cross-linker, the scintillator can be degraded compared to cross-linkers of the prior art or cross-linkers of the present invention. The amount of the cross-linker in the mixture is between about 0.5 wt. % and about 10 wt. % of the mixture. The cross-linker crosslinks the monomer to form a polymer. In some embodiments, the crosslinker can comprise between about 0 wt. % and about 0.5 wt. % of the mixture of the polymer.

The first dopant, or primary fluor, can be 2,5-diphenyloxazole (“PPO”), 9,9-dimethyl-2-phenyl-9H-fluorene (“PhF”), or combinations thereof. The second dopant, i.e. a wavelength shifter, can be 1,4-bis(5-phenyloxazol-2-yl) benzene (“POPOP”), 9,10-diphenylantracene (“DPA”), 9-9-dimethyl-2,7-di((E)-styryl)-9H-flourene (“SPS”), 1,4-bis(2-methylstyryl)benzene (“Bis-MSB”), and combinations thereof. The first dopant and the second dopant provide scintillation to the scintillator.

In some embodiments, the mixture can include at least one initiator. The initiator can be a radical initiator, such as a thermal radical initiator or a radical photo initiator. The initiator can be used to initiate cross-linking of the monomer in the mixture. One of skill in the art would understand that an initiator can decrease the time required for cross-linking of the polymer to occur. One skilled in the art would also understand that many different types of radical initiators could be used, and are so expansive in the number that could be applicable, that it would be impossible to list all of the potential initiators herein. One skilled in the art would also understand that an initiator is not required to polymerize the monomers as the polymerization reaction can occur without the initiator, but the polymerization time may increase. One skilled in the art would also understand other methods of cross-linking the polymer in the presence or absence of the initiator can be used. For example, the curing time and temperature of the mixture can be adjusted to promote polymerization of the monomers to form the polymer.

When an initiator is used, the curing temperature can depend upon the initiator. For example, in some embodiments, the initiator can be azobisisobutyronitrile (“AIBN”). The curing temperature can be between about 60° C. and about 90° C. when AIBN is used as the initiator. Other suitable initiators can include benzoyl peroxide, tert-amyl peroxybenzoate, 4, 4,-Azobis(4-(cyclohexanecarbonitrile), 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethyl cyclohexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, and combinations thereof. The curing temperature in general can be between about 20° C. and about 120° C. This general curing temperature of between 20° C. and about 120° C. can be utilized if the initiator is used or if an initiator is not included in the mixture. The curing time can be between about 24 and about 72 hours.

When the initiator is used, it is typically combined with the monomer to form a pre-mixture, which is then combined with the mixture (i.e. the mixture containing the first and second dopants, cross-linker and potentially other components). The amount of initiator in the pre-mixture (i.e. initiator and monomer mixture) can be between about 0.01 wt. % and about 0.1 wt. %. The premixture can be used as the amount of monomer in the mixture.

The monomer used with the invention can be a vinyl monomer, acrylate monomer, styrene-based monomer, or methacrylate monomer. Suitable monomers include vinyl toluene, styrene, methyl methacrylate, phenyl acrylate, phenyl methacrylate, benzyl acrylate, benzyl methacrylate and combinations thereof. The amount of the monomer can typically be the balance of the other components such that the total amount of the components in the mixture equals 100 wt. %. In some embodiments, incidental materials can also be present in the mixture, typically in amounts of up to about 5 wt. % of the mixture.

The mixture is purged prior to curing. Purging can remove oxygen present in the mixture and surrounding the mixture. The mixture can be purged with an inert gas for between about 5 and 30 minutes at a temperature between about 20° C. and about 40° C. Suitable inert gases include argon, nitrogen, and combinations thereof. In some embodiments, the mixture can be purged during the curing step.

The mixture can be subjected to a second cure. The second cure can occur after the first curing step. The second curing step can be continuous to the first cure step (i.e. after the first cure is complete at the first cure temperature, raising the temperature from the first curing temperature to the second curing temperature without removing the material from the heating device). Alternatively, the second curing step can occur after the first temperature has been reduced, for example to room temperature, then increased to the second curing temperature. The second cure can occur at a temperature of between about 80° C. and about 120° C., for between about 12 hours and about 48 hours, and at a pressure of between about 7.6 psi and about 9.8 psi.

The mixture includes a third dopant. The third dopant can enhance thermal neutron detection or induce photopeak for gamma spectroscopy. Suitable third dopants include, but are not limited to, bis(pinacolato)diboron (B₂Pin₂), m-carborane, 4,4,5,5-tetramethyl-2-phenyl-1,3,2-dioxaborolane (MBB), 2,2′,2″-(benzene-1,2,4-triyl)tris(4,4,5,5-tetramethyl-1,3,2-dioxaborolane) (124TrBB), lithium salicylate, triphenylbismuthane, or combinations thereof. The boron can be either from natural sources or enriched in 10B, that is the neutron active isotope of boron as it has a high neutron cross-section of 3840 barns. U.S. Pat. No. 9,864,077, entitled “Boron Containing Organic/Hybrid Scintillation Materials for Gamma and Neutron Detection, describes boron containing organic scintillation materials, and is incorporated by reference in its entirety. FIG. 15A-15K provide images of suitable first, second and third dopants that can be used with the invention.

The hardness of the pulse shape discriminating scintillator formed with methods of the invention can be between about 15 Shore-D and about 100 Shore-D as measured pursuant to ASTM D2240. In some embodiments, the Shore-D hardness can be between about 50 and about 95, and in some embodiments, the Shore-D hardness can be about 85. Furthermore, the pulse shape discriminating scintillator does not lose greater than about 0.1 wt. % (each) of the first dopant, and the second dopant over a period of between about 1 day and about 5 years. Additionally, the scintillator does not discolor after one year, which is another indication that the scintillator is stable over time. The scintillator can also be resistant to crazing over a period greater than at least one year. One issue known when a cross-linker is not utilized as described with regard to the present invention is that the dopants can seep from the scintillator, crystallize and cloud the scintillator. While not being bound by theory, it is believed that the inclusion of the cross-linker in the present invention can reduce or prevent the crystallization and clouding.

An aspect of the invention is a scintillator. The scintillator comprises between about 1 wt. % and about 20 wt. % of a first dopant, between 0.1 wt. % and about 1 wt. % of a second dopant, between about 5 wt. % and about 40 wt. % of a third dopant, and the balance being a polymer of monomers. An average hardness of the scintillator, as measured pursuant to ASTM D2240, is between about 15 and about 100 Shore-D.

The molecular structure of the cross-linking agent provides aromatic π-electrons. The cross-linker can include BPA-DM, BPAF-DM, BPA(halogen)-DM, a bifunctional aromatic acrylate and combinations thereof. The cross-linker is not a divinyl benzene. When divinyl benzene is used as the cross-linker, the scintillator can be degraded compared to cross-linkers of the prior art or cross-linkers of the present invention.

The first dopant, or primary fluor, can be 2,5-diphenyloxazole (“PPO”), 9,9-dimethyl-2-phenyl-9H-fluorene (“PhF”), or combinations thereof. The second dopant, i.e. a wavelength shifter, can be 1,4-bis(5-phenyloxazol-2-yl) benzene (“POPOP”), 9,10-diphenylantracene (“DPA”), 9-9-dimethyl-2,7-di((E)-styryl)-9H-flourene (“SPS”), 1,4-bis(2-methylstyryl)benzene (“Bis-MSB”), and combinations thereof. The first dopant and the second dopant provide scintillation to the scintillator.

In some embodiments, the scintillator can include at least one initiator. The initiator can be a radical initiator, such as a thermal radical initiator or a radical photo initiator. The initiator can be used to initiate cross-linking of the monomer in the mixture. In some embodiments, the initiator can be azobisisobutyronitrile (“AIBN”). Other suitable initiators can include benzoyl peroxide, tert-amyl peroxybenzoate, 4, 4,-Azobis(4-(cyclohexanecarbonitrile), 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclo-hexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, and combinations thereof.

The monomer used with the invention to form a polymer can be a vinyl monomer, acrylate monomer, a styrene-based monomer, or methacrylate monomer. Suitable monomers include vinyl toluene, styrene, methyl methacrylate, phenyl acrylate, phenyl methacrylate, benzyl acrylate, benzyl methacrylate and combinations thereof. The monomer polymerizes to form polymers of the monomer.

The scintillator can include a third dopant. The third dopant can enhance thermal neutron detection or induce photopeak for gamma spectroscopy. Suitable third dopants include, but are not limited to, bis(pinacolato)diboron (B₂Pin₂), m-carborane, 4,4,5,5-tetramethyl-2-phenyl-1,3,2-dioxaborolane (MBB), 2,2′,2″-(benzene-1,2,4-triyl)tris(4,4,5,5-tetramethyl-1,3,2-dioxaborolane) (124TrBB), lithium salicylate, triphenylbismuthane, or combinations thereof. The boron can be either from natural sources or enriched in 10B, that is the neutron active isotope of boron as it has a high neutron cross-section of 3840 barns. U.S. Pat. No. 9,864,077, entitled “Boron Containing Organic/Hybrid Scintillation Materials for Gamma and Neutron Detection, describes boron containing organic scintillation materials, and is incorporated by reference in its entirety. When the third dopant is used, the amount of the other components, typically the first dopant and/or monomer/polymer, can be reduced. As a result, the amount of the third dopant can be between about 0 wt. % and about 40 wt. % of the mixture. However, when the third dopant is included in the scintillator, then the amount of the third dopant can be greater than about 0 wt. % and about 40 wt. % of the mixture. FIG. 15A-15K provide images of suitable first, second and third dopants that can be used with the invention.

The hardness of the pulse shape discriminating scintillator formed with methods of the invention can be between about 15 Shore-D and about 100 Shore-D as measured pursuant to ASTM D2240. In some embodiments, the Shore-D hardness can be between about 50 and about 95, and in some embodiments, the Shore-D hardness can be about 85. Furthermore, the pulse shape discriminating scintillator does not lose greater than about 0.1 wt. % (each) of the first dopant, and the second dopant over a period of between about 1 day and about 5 years. Additionally, the scintillator does not discolor after one year, which is another indication that the scintillator is stable over time. The scintillator can also be resistant to crazing over a period greater than at least one year. One issue known when a cross-linker is not utilized as described with regard to the present invention is that the dopants can seep from the scintillator, crystallize and cloud the scintillator. While not being bound by theory, it is believed that the inclusion of the cross-linker in the present invention can reduce or prevent the crystallization and clouding.

An aspect of the invention is a method to use at least one scintillator to detect neutrons or gamma response. The method includes subjecting the scintillator to an environment to detect neutrons or gamma response. The scintillator can include between about 20 wt. % and about 40 wt. % of a first dopant, between about 0.1 wt. % and about 1 wt. % of a second dopant, and the balance being a polymer of monomers, or the scintillator can include between about 1 wt. % and about 20 wt. % of a first dopant, between about 0.1 wt. % and about 1 wt. % of a second dopant, between about 5 wt. % and about 40 wt. % of a third dopant, and the balance being a polymer of monomers. An average hardness of the scintillator, as measured pursuant to ASTM D2240, is between about 15 and about 100 Shore-D.

Neutrons present in the object or area can be detected with the scintillator, which can be incorporated into an apparatus. The apparatus can be used in any suitable application to detect the neutron, including but not limited to, oil and gas operations (including drilling, fracking, completing, and the like), a person, specialty materials (for example, special nuclear materials such as uranium or plutonium), reactor area, laboratories, cargo, or other areas where the presence of neutrons is known or suspected. The method can also be used to detect neutron and gamma signals in airport security, or neutron therapy, for example.

### EXAMPLE

### Example 1

### Manufacturing of Samples

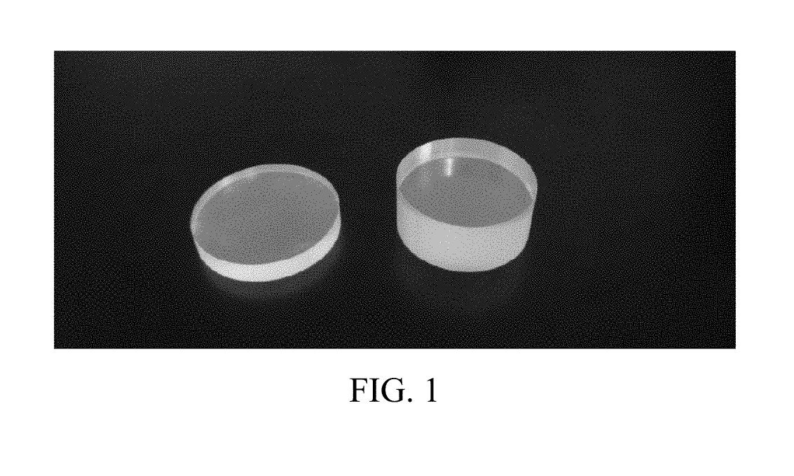

Several PPO-overdoped PVT samples, cross-linked to varying extents with BPA-DM, were tested for scintillation performance and mechanical properties. The samples generally had masses of between about 20 grams and about 40 grams, and were machined on a lathe to disks with diameters of about 1.7″ and thicknesses between about 0.25″ and 1″; two of the test samples are illustrated in FIG. 1.

### Testing

Light output was measured relative to a commercial Saint Gobain Crystals BC-408 (anthracene 64%) sample that was machined to approximately the same size as the polymer samples. The quality of PSD was quantified by analysis of delayed pulse content compared to total pulse content in the digitized waveforms from a Hamamatsu photomultiplier tube (PMT).

The gamma response of each sample was measured using a ¹³⁷Cs (˜1 μCi) source. The collected, integrated PMT anode pulse content spectra produced a visible Compton edge for each sample, which was used to calculate a sample specific light yield by comparing the position of the edge to one produced from a commercial scintillator (BC-408) machined to the same size as the samples. Samples were also exposed to a mixed neutron and gamma radiation field emanating from a ²⁴⁴Cm/¹³C (˜60 mCi) source. The response for each sample was measured on a keVₑₑ (kilo-electron Volt, electron equivalent) scale, calibrated using the ¹³⁷Cs response spectrum. The quality of the PSD in each sample was quantified by a dimensionless Figure of Merit (FoM) based on equation 1 through analysis of a delayed pulse content interval compared to total pulse content in the analyzed waveforms.

$$FoM = \frac{{Centroid}_{n} - {Centroid}_{g}}{{FWHM}_{n} + {FWHM}_{g}} \qquad ( 1 )$$

With typical decay times of order ˜8-10 nsec, a delayed integration time window from 32-120 nsec is compared to the total integrated pulse content in order to display PSD. The FoM metric was calculated for both 100-200 keVₑₑ and 400-600 keVₑₑ energy cut intervals.

The hardness of the polymer samples was tested both objectively on the Shore D hardness scale and subjectively for machinability on a belt sander and a polishing wheel, noting if a sample melted with the added friction. A Shore-D durometer (GxPro model#560-10D) was used to quantify the hardness. The Shore-D values were obtained pursuant to ASTM D2440, where 6 equidistant points were sampled on the face of the sample for ˜1 second and then averaged.

Thermal stability was quantified via thermal gravimetric analysis (TGA) using a Q200 TA Instrument. To determine the decomposition temperature (T_{d}) of the plastics, portions were typically cut from the top edge of the plastic scintillator samples and ramped at about 15° C. per minute to about 600° C. under an inert nitrogen atmosphere. Similar portions were cut from samples to use for differential scanning calorimetry (DSC) measurements to determine glass transition temperatures (T_{g}). DSC was performed on the Q2000 T A Instrument by heating from about −5° C. to about 150° C. at a ramp rate of about 10° C. per minute. TGA and DSC analysis used Universal Thermal Analysis software. Portions were also taken from the interior of the scintillators, but no difference was observed.

Contact angle measurements were used to illustrate the hydrophobic nature of a sample. Contact angle measurements were made on a Ramé-Hart Instrument Co. Standard Goniometer (Model No. 200-00) using about 10 microliter deionized water droplets. Analysis was performed on DropImage software.

Admixing the different cross-linkers into the monomer significantly affected the rate of polymerization. These effects were quantified as compared to pure monomer via gravimetric measurements adapted from established methods in literature^{23,24}. A stock solution of 0.01 wt. % AIBN in VT monomer was used to dissolve about 2 wt. % of cross-linker. Solutions were degassed with argon for about 10 minutes in glass vials before being heated at about 80° C. in an oil bath. Aliquots of the polymerizing solution were removed via micropipette at designated times and cooled to about 0° C. in an ice bath. The aliquot was dissolved in toluene then precipitated in cold methanol while stirring. The precipitate was filtered off, dried in ambient conditions, and weighed. The rate of change of the ratio of polymer to remaining monomer in time is indicative of the reactivity of the different cross-linkers.

### Results

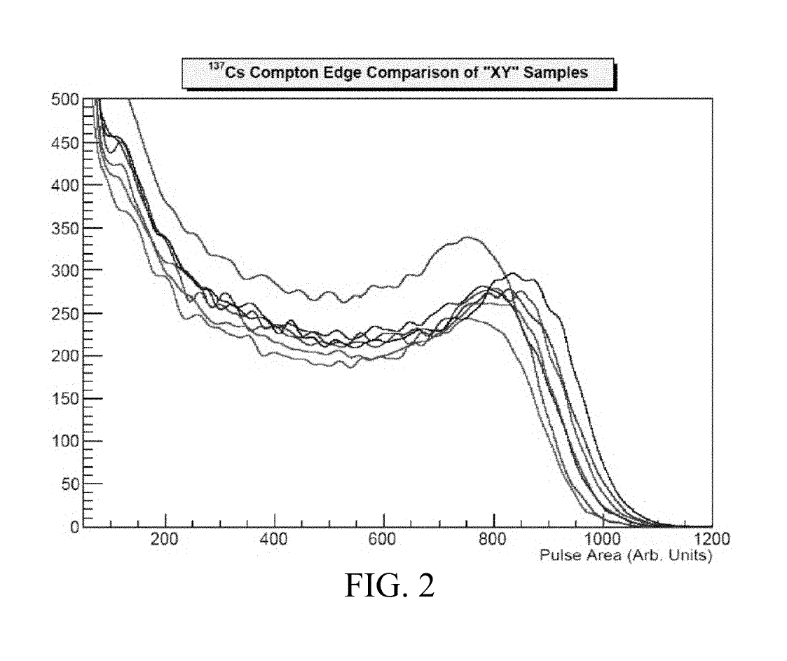

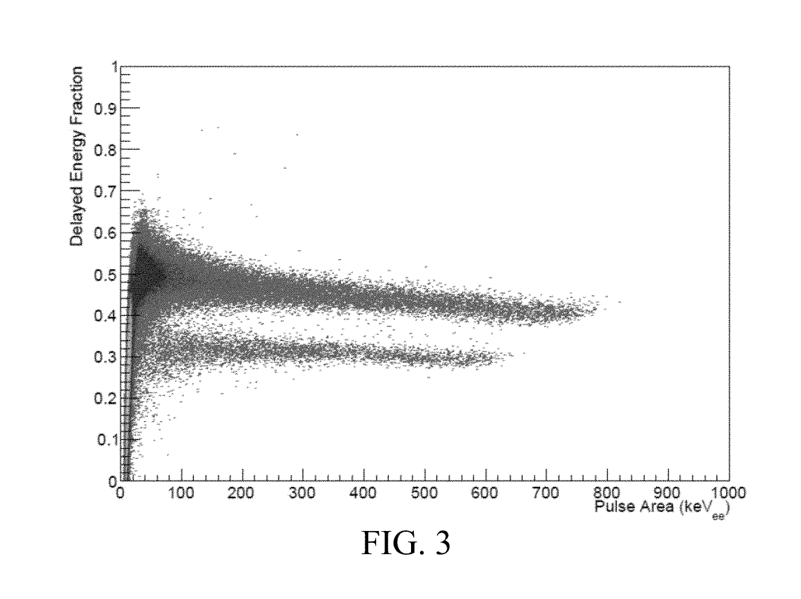

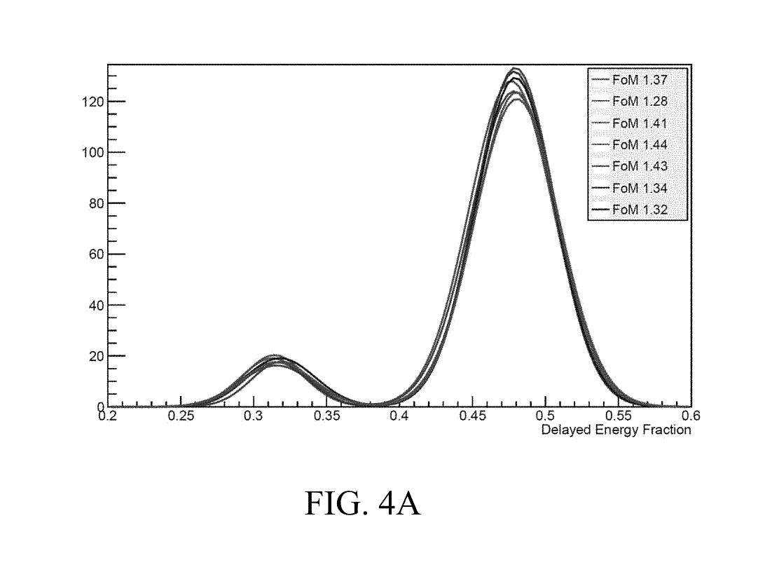

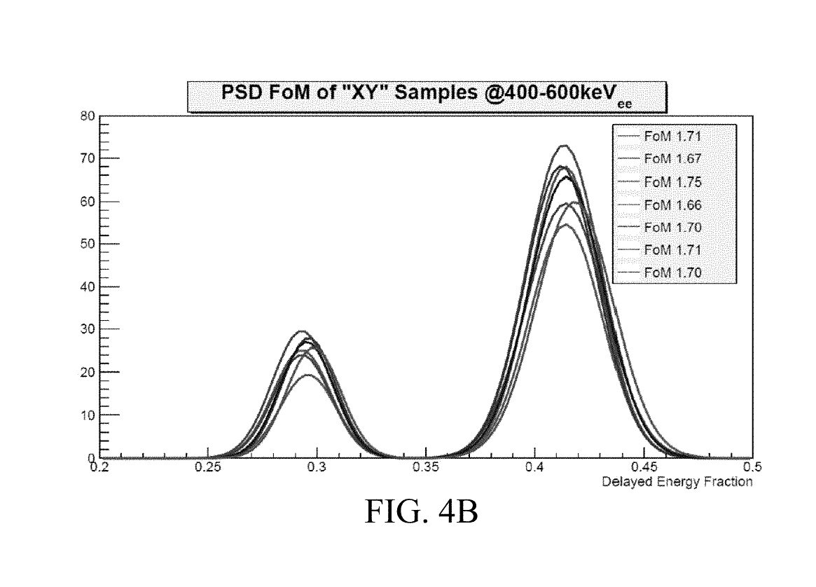

Referring to FIGS. 2 through 4, the pulse content spectrum (FIG. 2) was calibrated in units of kilo-electron volt electron equivalent (keVₑₑ) using a ¹³⁷Cs gamma photon source. In a spectrum displaying delayed pulse content versus total pulse content, the neutron and gamma energy deposits from a ²⁴⁴Cm/¹³C mixed source was separated into two bands (FIG. 3). The PSD quality was then quantified by extracting two figures of merit (FoM) from the spectra. In FIGS. 4A and 4B, two energy intervals (100-200 keVₑₑ and 400-600 keVₑₑ, respectively) are defined and projected separately on the y-axis. The two visible peaks, respectively corresponding to neutrons and gamma photons, are fitted by Gaussian functions and a comparison of peak widths with peak separation yields a figure of merit as a measure of PSD, with a higher number indicating better separation and/or discrimination.

In addition to successfully enhancing the hardness and machinability of plastic scintillators, BPA-DM did not degrade the measured radiation response of the scintillators. As observed in FIGS. 1, 3, 4A and 4B, and fully detailed in Table 1, over-doped samples with varying amount of cross-linker show excellent and consistent PSD. Furthermore, there is no light output reduction observed in any of the cross-linked samples, with high concentrations of BPA-DM producing slightly enhanced light yields

The commercial BC-408 sample was a standard plastic scintillator sample with high light output and no PSD properties that exhibited a Shore D hardness of 85. A simple PVT-based non-PSD scintillator, doped with about 1% PPO and about 0.1% POPOP achieved an average Shore D value of about 83. The light output of the samples of the present invention generally varied between about 95% and about 100% of the BC-408 output. PSD was achieved by overdoping with PPO (more than about 10 wt. %), but as expected, overdoping with PPO softens the plastic material and results in a slight (about 10-12%) loss of light output. Samples comprising 20%, 25% and 30% PPO had Shore D hardness values of 66, 65, and 6 (Table 1, 0% crosslinker), respectively, and light output relative to the BC-408 sample was about 87%, about 81%, and about 89%, respectively. The unmodified overdoped samples required hand-sanding and very gentle polishing to achieve usable surfaces, and were generally soft enough to be bent by hand.

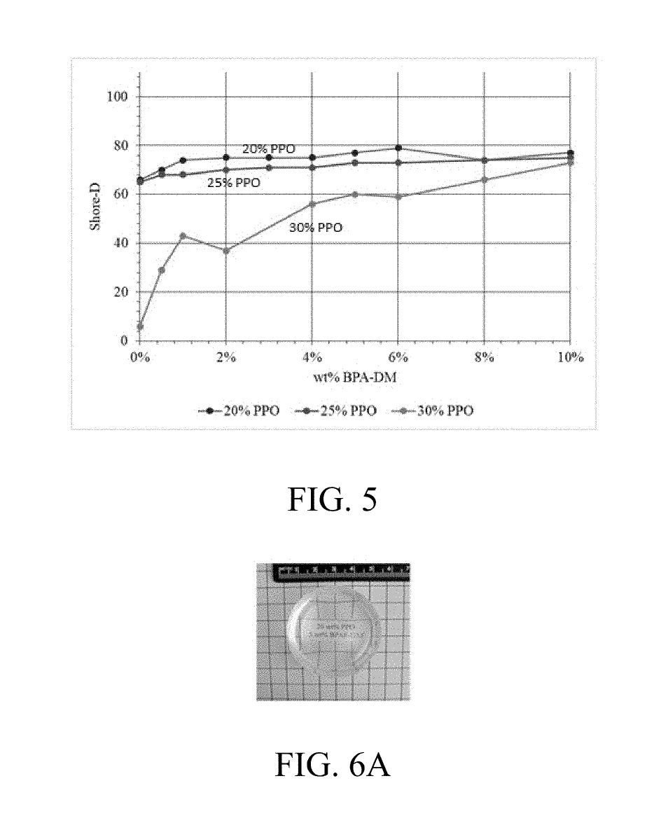

Table 1 above includes data pertaining to PPO-overdoped scintillators with varying BPA-DM contents, i.e. varying degrees of cross-linking. All samples with BPA-DM content of 3% or higher could be belt-sanded and machine-polished, and at BPA-DM contents of 5% and higher no melting was observed even with very aggressive polishing. An experiment focused on improving hardness and machinability in over-doped PPO plastic scintillators. For comparison, the commercial BC-408 sample, which has low primary dopant concentration and does not display PSD, has a Shore-D value of 85. Varying amounts of BPA-DM were used with 20, 25, and 30 wt. % PPO. Increasing BPA-DM content led to an increase in Shore-D hardness (illustrated in FIG. 5) as well as a significant improvement in machinability. For example, at ≥about 3 wt. % BPA-DM the samples could be belt sanded and machine polished without melting. Samples containing ≥about 5 wt. % BPA-DM could withstand aggressive sanding and wheel polishing without exhibiting induced friction melting or self-agglomeration. The same trend was observed for BPAF-DM modified samples (see Table 1).

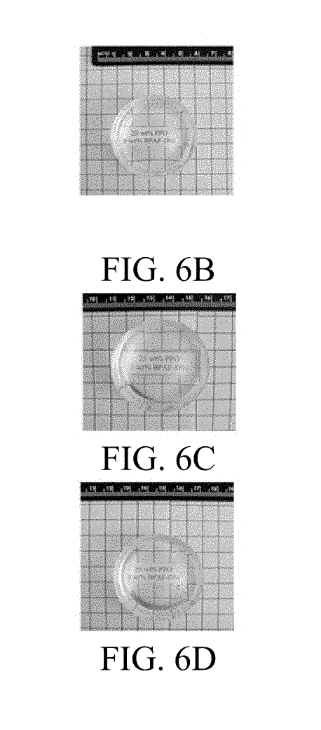

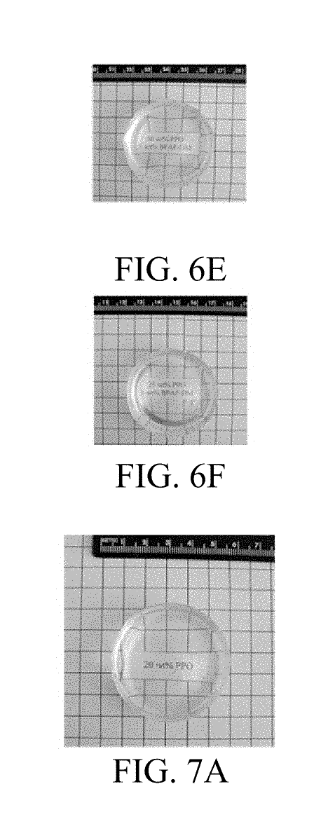

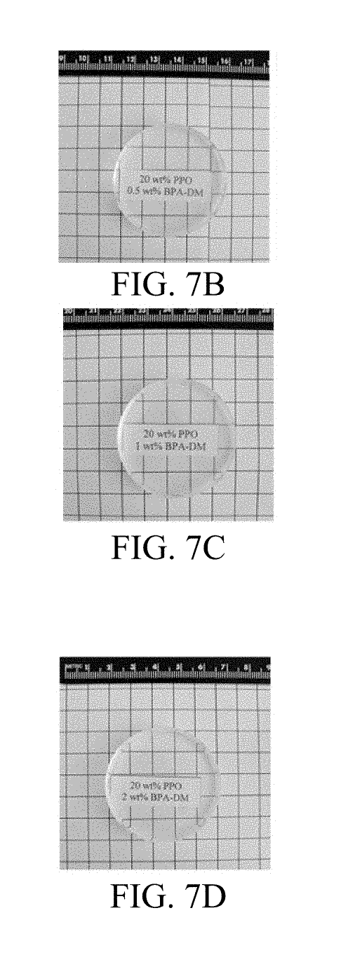

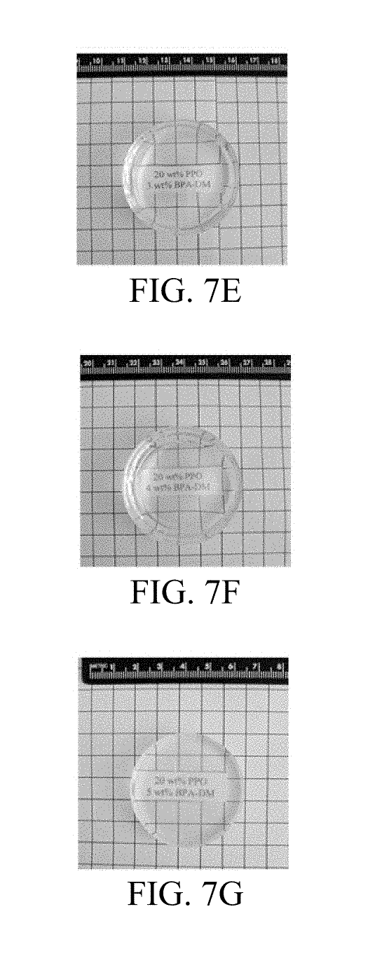

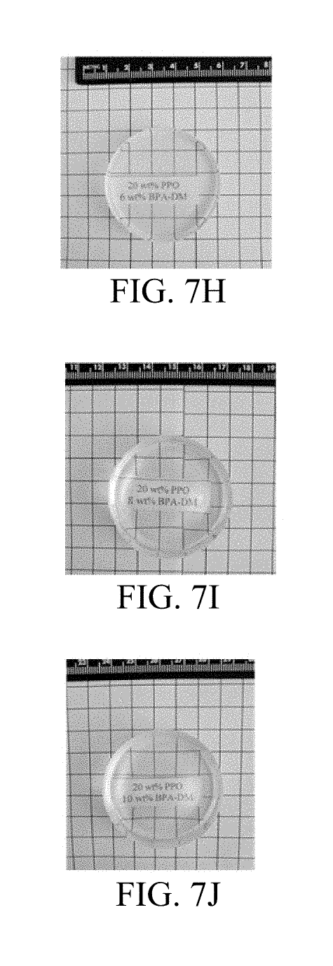

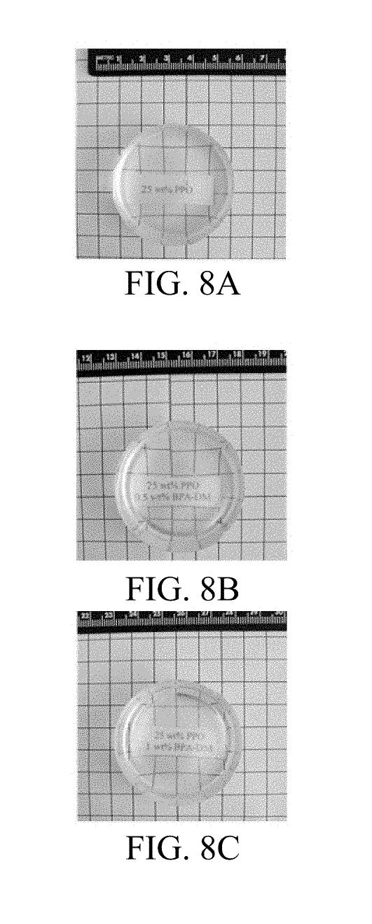

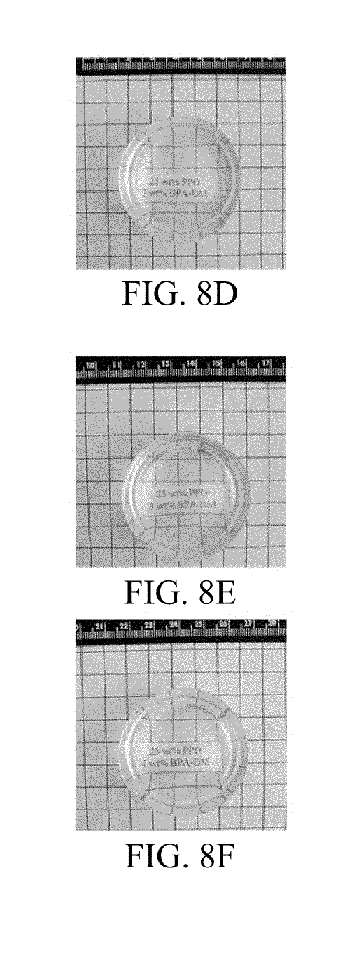

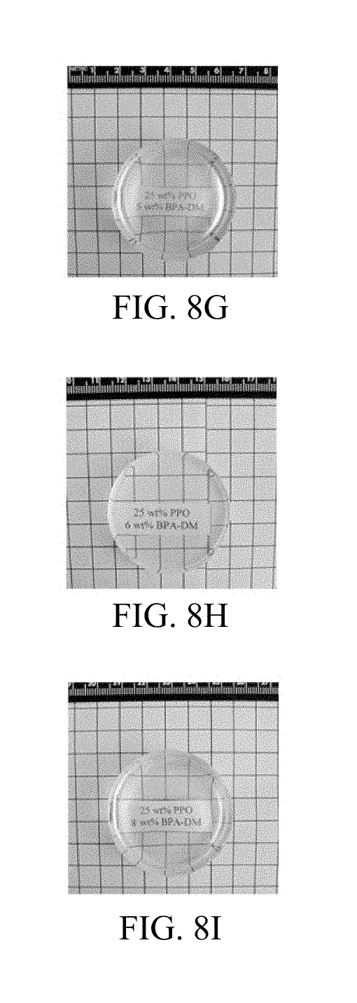

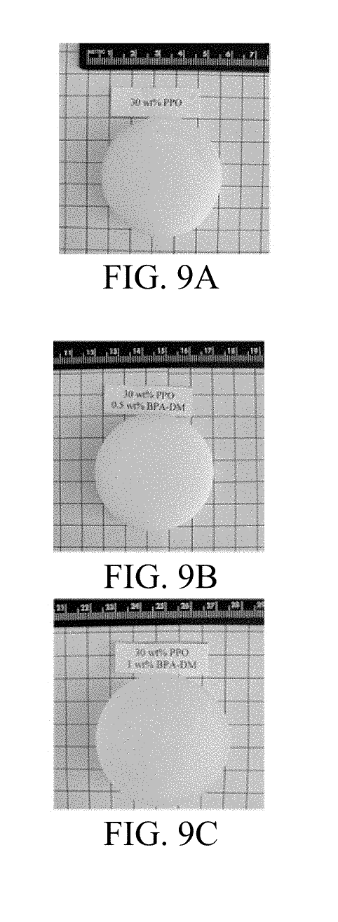

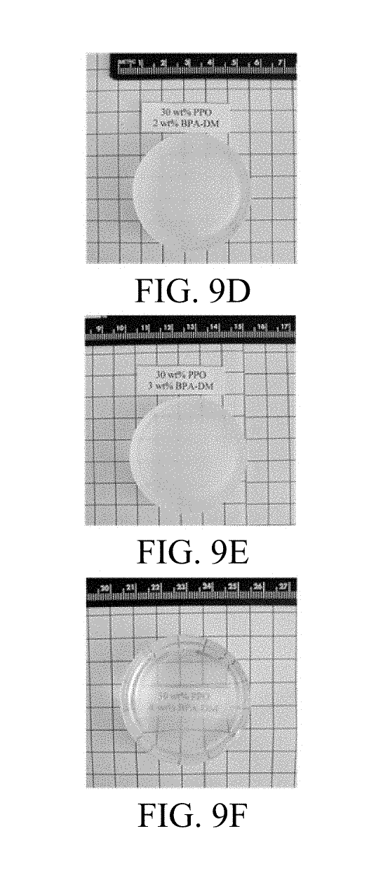

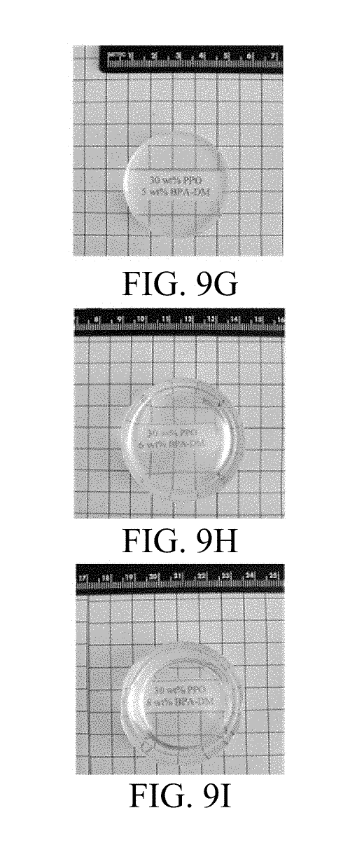

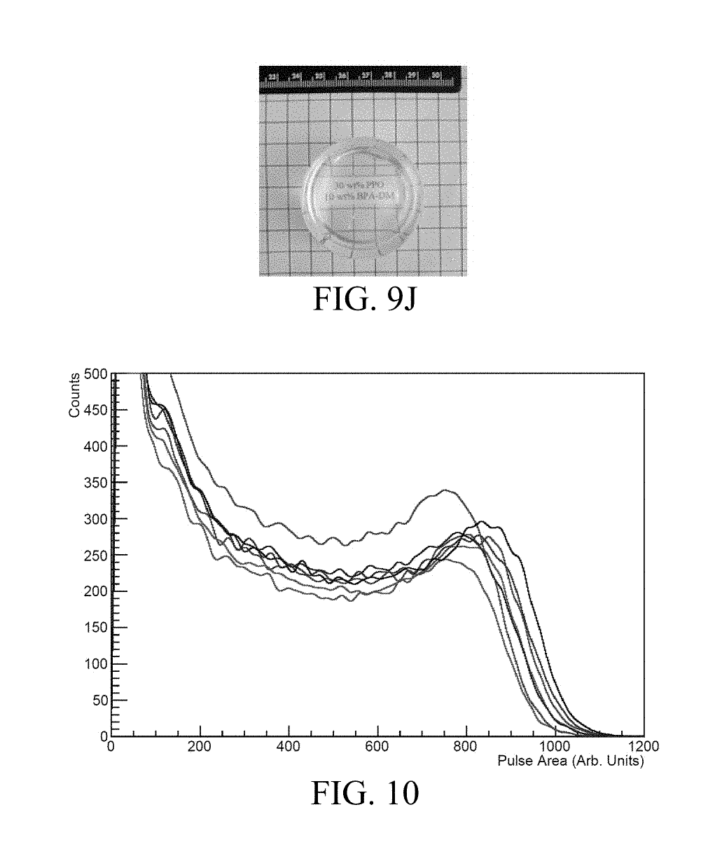

Cross-linking had the most pronounced effect in the 30 wt. % PPO samples. Without cross-linkers, the over-doped samples were very soft, bendable and could not be fully machined and polished. In all the unmodified over-doped plastics, the PPO quickly crystallized (within hours to under a week depending on the dopant concentration), leading to opaque scintillators. FIG. 6A-6F illustrates samples of varying amounts of PPO with 5 wt. % or 8 wt. % of BPAF-DM. The samples of the top row each contain 5 wt. % BPAF-DM, while the samples on bottom row each contain 8 wt. % of BPAF-DM. Each sample is translucent. FIGS. 7A-7J illustrates samples of varying amounts of crosslinker with 20 wt. % PPO. The control sample illustrated in FIG. 7A (i.e. no crosslinker) is clear. FIG. 8A-8I illustrate samples containing 25 wt. % PPO and varying amounts of the crosslinker. The control sample illustrated in FIG. 8A (i.e. no cross-linker) is cloudy compared to the other samples. FIG. 9A-9J illustrates samples containing 30 wt. % PPO and varying amounts of the crosslinker (BPA-DM). After about 2 wt. % of the crosslinker (FIG. 9D), the samples start to become translucent. By cross-linking the scintillators, significant increases in hardness were observed together with a complete suppression of dopant crystallization. The cross-linked scintillators remain clear, colorless, and hard after >8 months of ambient storage as illustrated in FIGS. 1, 7A-J, 8A-I, and 9A-J. The cross-linked polymer matrix appears to inhibit diffusion of PPO, preventing the formation of aggregates that lead to opaque scintillators.

In the over-doped plastic scintillators crosslinked with BPAF-DM (illustrated in FIG. 6), light yield and PSD capabilities remain comparable to unmodified scintillators. Overall, these samples are harder than non-crosslinked over-doped plastics, but not as robust as BPA-DM based samples (see Shore-D and glass transition temperature (T_{g}) values detailed in Table 1-3). Table 2 provides thermal Decomposition of BPA-DM. Onset 1 is likely PPO sublimation from the plastic sample. Table 3 provides thermal decomposition of BPAF-DM modified scintillators. Onset 1 is likely PPO sublimation from the plastic sample. All values in Tables 2 and 3 are approximate.

TABLE 2

| | BPA- | | | | Max | |
|---|---|---|---|---|---|---|
| PPO | DM | Onset 1 | Onset 2 | T_{max slope} | slope | T_{g} |
| (wt. %) | (wt. %) | (° C.) | (° C.) | (° C.) | (wt. %/° C.) | (° C.) |
| 20 | 0 | 165.1 ± 4.8 | 368.8 ± 2.6 | 399.3 ± 1.8 | 1.40 ± 0.05 | 36.3 ± 0.5 |
| | 5 | 179.0 ± 4.5 | 355.6 ± 14.4 | 400.0 ± 2.3 | 1.20 ± 0.17 | 57.9 ± 2.8 |
| | 8 | 154.4 ± 2.6 | 345.4 ± 3.2 | 393.1 ± 4.1 | 1.04 ± 0.04 | 49.6 ± 0.5 |
| 25 | 0 | 181.9 ± 4.7 | 362.4 ± 2.1 | 397.2 ± 1.0 | 1.21 ± 0.04 | 30.1 ± 1.0 |
| | 5 | 181.4 ± 0.5 | 367.9 ± 3.6 | 402.7 ± 0.9 | 1.16 ± 0.13 | 42.5 ± 2.0 |
| | 8 | 176.5 ± 5.1 | 357.1 ± 6.3 | 401.9 ± 2.8 | 1.03 ± 0.02 | 48.8 ± 4.7 |
| 30 | 0 | 183.3 ± 2.1 | 375.4 ± 1.1 | 403.5 ± 1.1 | 1.21 ± 0.02 | 20.7 ± 2.0 |
| | 5 | 167.0 ± 1.7 | 361.9 ± 7.9 | 396.5 ± 1.2 | 1.11 ± 0.09 | 31.2 ± 2.4 |
| | 8 | 182.9 ± 1.9 | 369.0 ± 3.2 | 402.4 ± 2.3 | 1.02 ± 0.01 | 34.8 ± 0.4 |

TABLE 3

| | BPAF- | | | | Max | |
|---|---|---|---|---|---|---|
| PPO | DM | Onset 1 | Onset 2 | T_{max slope} | Slope | T_{g} |
| (wt. %) | (wt. %) | (° C.) | (° C.) | (° C.) | (wt. %/° C.) | (° C.) |
| 20 | 0 | 165.1 ± 4.8 | 358.8 ± 2.6 | 399.3 ± 1.8 | 1.4 ± 0.05 | 36.3 ± 0.5 |
| | 5 | 164.9 ± 0.6 | 357.7 ± 5.9 | 393.5 ± 2.7 | 1.3 ± 0.14 | 43.2 ± 1.3 |
| | 8 | 166.7 ± 2.3 | 362.7 ± 9.2 | 396.5 ± 0.3 | 1.2 ± 0.11 | 45.0 ± 1.0 |
| 25 | 0 | 181.9 ± 4.7 | 362.4 ± 2.1 | 397.2 ± 1.0 | 1.2 ± 0.04 | 30.1 ± 1.0 |
| | 5 | 175.2 ± 1.7 | 361.9 ± 4.8 | 394.4 ± 2.2 | 1.1 ± 0.09 | 24.1 ± 0.9 |
| | 8 | 164.4 ± 1.4 | 359.7 ± 2.8 | 398.1 ± 1.9 | 1.1 ± 0.03 | 32.0 ± 0.7 |
| 30 | 0 | 183.3 ± 2.1 | 375.4 ± 1.1 | 403.5 ± 1.1 | 1.2 ± 0.02 | 20.7 ± 2.0 |
| | 5 | 173.0 ± 3.0 | 363.7 ± 5.2 | 396.5 ± 0.3 | 1.2 ± 0.12 | 27.5 ± 0.9 |
| | 8 | 164.1 ± 4.1 | 380.5 ± 11.5 | 399.7 ± 3.2 | 1.2 ± 0.03 | 22.6 ± 2.8 |

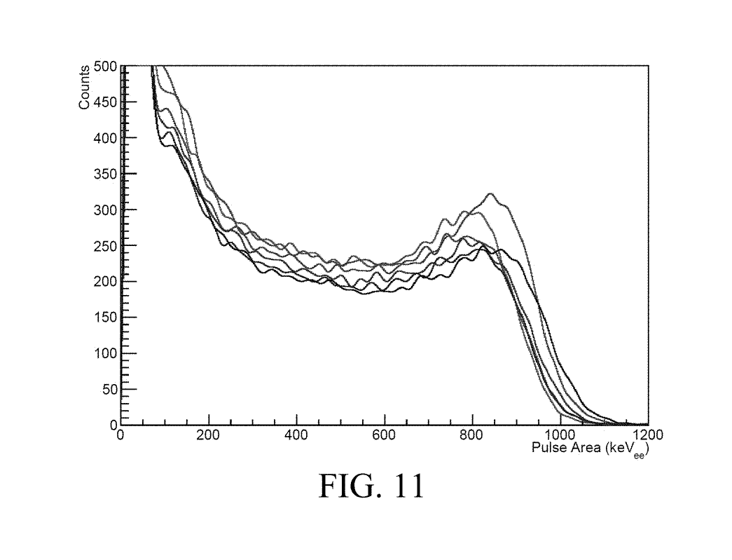

FIG. 10 illustrates the radiation response spectra for crosslinked samples. The radiation response is the ¹³⁷Cs Compton edge features of plastic scintillators with varying concentrations (0-10 wt. %) of BPA-DM and 20 wt. % PPO. FIG. 11 illustrates the ¹³⁷Cs Compton edge features of BPAF-DM linked samples (detailed in Table 1).

The thermal properties of over-doped plastic scintillators crosslinked with BPA-DM were compared to the analogous unmodified samples using DSC and TGA analysis. All BPA-DM cross-linked samples have a higher glass transition temperatures (T_{g}) than the unmodified PPO samples, indicating cross-linking enhances the thermal stability of the plastics (Table 4). As the concentration of PPO increased, the T_{g} decreased, which is expected and most likely due to PPO acting as a plasticizer within these scintillators. The same thermal stability effects were observed for BPAF-DM modified samples leading to machinable scintillators, but less pronounced as compared to the BPA-DM samples.

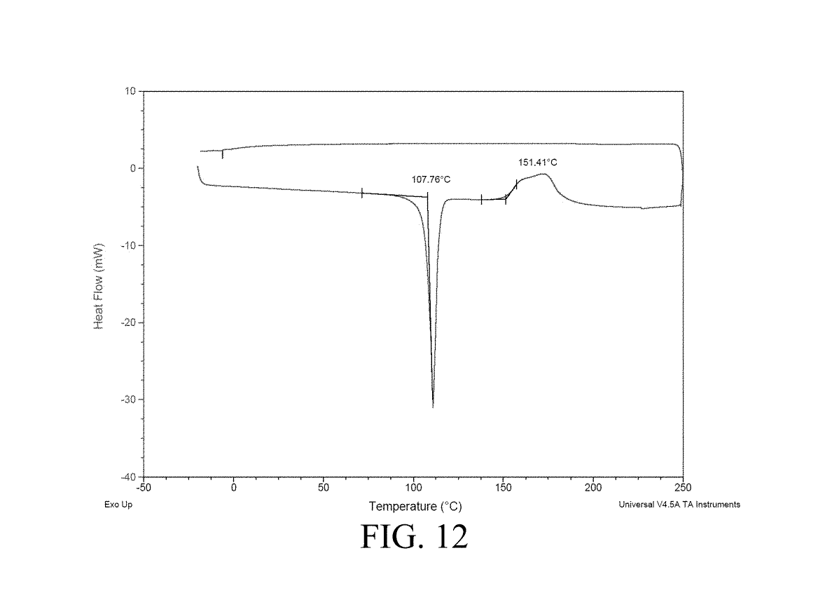

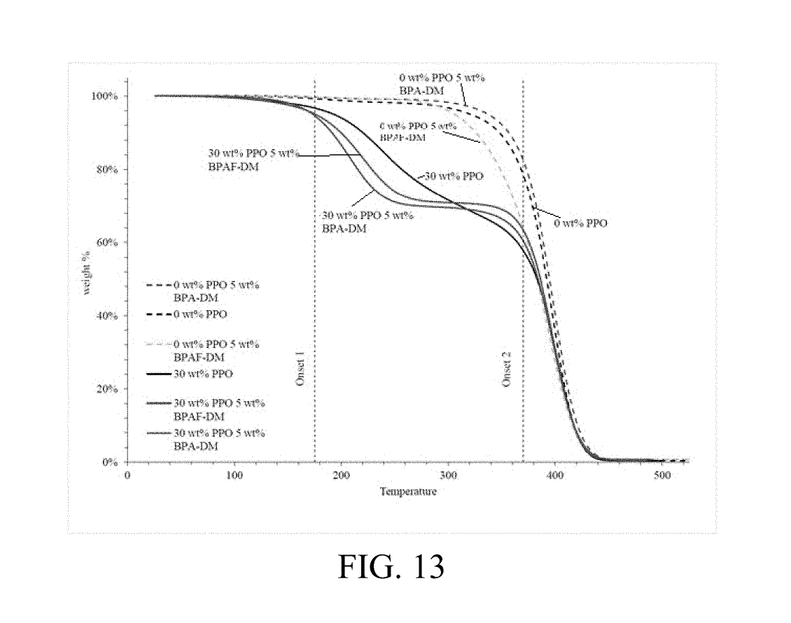

FIG. 12 illustrates the DSC curve for BPAF-DM. DSC indicated a melting temperature of BPAF-DM of about 108° C., and a polymerization peak of around 152° C. TGA revealed decomposition temperatures (T_{d}) of >350° C. for samples without PPO. For scintillators containing about 30 wt. % PPO, weight loss begins at about 170° C. and stabilizes at about 70% weight at about 260° C. FIG. 13 illustrates the thermal decomposition curves for cross-linked and uncross-linked samples. This is likely due to the sublimation of PPO as the T_{d} of PPO is much higher than this (a stated boiling point at 360° C. under reduced pressure). The decomposition of the remaining cross-linked polymer matrix then begins over 350° C. like the non-PPO containing samples. Cross-linked samples exhibit a slower maximum decomposition rate, attributed to cross-linkers impeding decomposition of the polymer matrix.

Table 4 illustrates the thermal stability of BPA-DM and BPAF-DM cross-linked samples. Samples I contain about 20 wt. % of PPO (first dopant), Sample II contain about 25 wt. % of PPO, and Samples III contain about 30 wt. % of PPO. All amounts in the table are approximate.

TABLE 4

| | T_{g} (° C.) | | |
|---|---|---|---|
| Cross-Linker | I | II | III |
| 0 wt. % | 36.3 ± | 30.1 ± | 20.7 ± |
| | 0.5 | 1.0 | 2.0 |
| 5 wt. % BPA-DM | 57.9± | 42.5± | 31.2 ± |
| | 2.8 | 2.0 | 2.4 |
| 8 wt. % BPA-DM | 49.6 ± | 48.8 ± | 34.8 ± |
| | 0.5 | 4.7 | 0.4 |
| 5 wt. % BPAF- | 43.2 ± | 24.1 ± | 27.5 ± |
| DM | 1.3 | 0.9 | 0.9 |
| 8 wt. % BPAF- | 45.0 ± | 32.0 ± | 22.6 ± |
| DM | 1.0 | 0.7 | 2.8 |

When plastic scintillators are exposed to humid conditions and fluctuating temperatures, water vapor is absorbed by the matrix and can cause a fogging effect which leads to degradation of the radiation response signals. It may be possible to mitigate this issue by increasing the hydrophobicity of the plastics' exposed surfaces. Fluorinated polymers tend to be more hydrophobic, so the contact angles of BPA-DM and BPAF-DM samples were measured to quantify the hydrophobicity of the prepared plastic scintillator surfaces. As shown in Table 5, varying the amount of BPA-DM did not induce a significant change in the hydrophobicity of the plastics. Comparison to an unmodified PVT sample indicated a slight worsening, possibly due to the high concentration of PPO. Samples cross-linked with BPAF-DM displayed on average, a measurable increase in contact angle, which is attributed to the increased fluorine content as shown in other cases in the literature. The larger contact angle indicates the surfaces of BPAF-DM crosslinked samples are more hydrophobic, which may help stabilize scintillators in humid conditions. The measured contact angles of the cross-linked scintillator samples are approximate in Table 5.

TABLE 5

| | Contact Angle (Degrees) | | | | |
|---|---|---|---|---|---|
| | 0 | 5 wt. % | | 8 wt. % | |
| PPO | wt. % | BPA- | BPAF- | BPA- | BPAF- |
| (wt. %) | — | DM | DM | DM | DM |
| 20 | 97 ± 3 | 94 ± 5 | 94 ± 6 | 94 ± 5 | 104 ± 1 |
| 25 | 97 ± 1 | 89 ± 7 | 106 ± 2 | 88 ± 8 | 102 ± 2 |
| 30 | 92 ± 6 | 93 ± 3 | 102 ± 1 | 93 ± 8 | 98 ± 2 |
| Overall | 96 ± 4 | 92 ± 6 | 101 ± 6 | 93 ± 8 | 101 ± 2 |
| Average | | | | | |

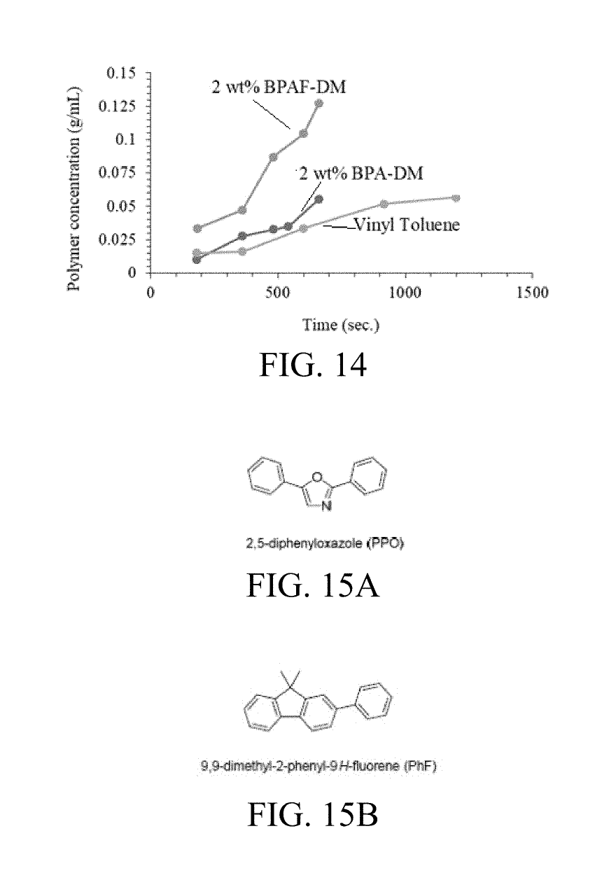

When polymerized under the conventional conditions as described above, BPAF-DM samples appeared to polymerize more rapidly, leading to clouding and poor-quality samples. To verify this, the rates of polymerization were compared (illustrated in FIG. 14). Based on this increased reactivity, BPAF-DM based samples were produced by heating for 24 hours at 60° C., 24 hours at 70° C., 48 hours at 80° C., and 24 hours at 90° C. This slower heating profile led to clear and colorless samples allowing further testing and characterization (FIG. 6A-6F).

Ranges have been discussed and used within the forgoing description. One skilled in the art would understand that any sub-range within the stated range would be suitable, as would any number within the broad range, without deviating from the invention.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described above is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A method for producing a pulse shape discriminating scintillator, comprising:
combining between about 20 wt. % and 40 wt. % of a first dopant, between about 0.01 wt. % and about 2 wt. % of a secondary dopant, at least 0.5 wt. % of at least one cross-linking agent, and a balance of at least one monomer, wherein the at least one monomer is a styrene-based monomer, methacrylate monomer, a benzyl acrylate, or a benzyl methacrylate, to form a mixture;
purging the mixture with an inert gas; and
curing the mixture at a temperature between about 60° C. and about 110° C. to form the pulse shape discriminating capable scintillator.

2. The method of claim 1, wherein a molecular structure of the cross-linking agent provides aromatic π-electrons.

3. The method of claim 1, wherein the at least one cross-linking agent comprises at least one of a bisphenol A dimethacrylate, a halogenated bisphenol A dimethacrylate, or a di-functional aromatic acrylate.

4. The method of claim 1, wherein the mixture comprises less than or equal to about 10 wt. % of the cross-linking agent.

5. The method of claim 1, further comprising at least one initiator.

6. The method of claim 5, wherein the at least one initiator is azobisisobutyronitrile AIBN.

7. The method of claim 6, wherein between about 0.01 wt. % and about 0.1 wt. % of the initiator is combined with the monomer to form a premixture, wherein the premixture is substituted for the monomer in the mixture.

8. The method of claim 1, further comprising a second curing at a temperature between about 80° C. and about 110° C.

9. The method of claim 1, wherein the monomer is a vinyl toluene, styrene, methyl methacrylate, phenyl acrylate, phenyl methacrylate, and combinations thereof.

10. The method of claim 1, wherein the mixture does not include an initiator.

11. The method of claim 1, wherein the at least one first dopant is 2,5-diphenyloxazole (PPO), or 9,9-dimethyl-2-phenyl-9H-fluorene (PhF).

12. The method of claim 1, wherein the at least secondary dopant is 9,10-diphenylanthracene (DPA), 9,9-dimethyl-2,7-di((E)-styryl)-9H-fluorene (SFS), 1,4-bis(5-phenyl-2-oxazolyl)benzene (POPOP), or 1,4-bis(2-methylstyryl)benzene (Bis-MSB).

13. The method of claim 1, wherein a hardness of the pulse shape discriminating scintillator is between about 15 Shore-D and about 100 Shore-D.

14. The method of claim 1, wherein the pulse shape discriminating scintillator does not discolor over a period between about 1 day and about 5 years.

15. The method of claim 1, wherein the cross-linker is not a divinyl benzene.

16. A pulse shape discriminating scintillator, comprising a polymeric material, the polymeric material comprising:
between about 20 wt. % and 30 wt. % of at least one first dopant, between about 0.01 wt. % and about 2 wt. % of a second dopant, and a balance of at least one monomer, wherein the at least one monomer is a styrene-based monomer, methacrylate monomer, benzyl acrylate, or benzyl methacrylate, wherein a hardness of the pulse shape discriminating scintillator is between about 15 and about 100 Shore D.

17. The scintillator of claim 16, wherein the hardness is between about 50 and about 95 Shore D.

18. The scintillator of claim 16, wherein a cross-linker used to make the scintillator is not comprise divinyl benzene.

19. A method of using a pulse shaped discriminating scintillator, comprising:
detecting a neutron with the pulse shaped discriminating scintillator, wherein a material of the pulse shaped discriminating scintillator comprises at least one of:
a first scintillator, comprising:
between about 20 wt. % and about 40 wt. % of a first dopant;
between about 0.1 wt. % and about 1 wt. % of a second dopant; and
the balance being a polymer of monomers; or
a second scintillator, comprising:
between about 1 wt. % and about 20 wt. % of a first dopant;
between about 0.1 wt. % and about 1 wt. % of a second dopant;
between about 5 wt. % and about 40 wt. % of a third dopant; and
the balance being a polymer of monomers;
wherein the monomer comprises at least one monomer of a styrene-based monomer, methacrylate monomer, benzyl acrylate, or benzyl methacrylate, and wherein a hardness of the pulse shape discriminating scintillator is between about 15 and about 100 Shore D.

20. The method of claim 19, wherein the pulse shaped discriminating scintillator is the first scintillator.
